(19) United States
(12) Patent Application Publication
(10) Pub. No.: US 2019/0036800 A1
(43) Pub. Date: Jan. 31, 2019

(54) DETERMINING A LOOP LENGTH OF A LINK

(71) Applicant: ADTRAN, Inc., Huntsville, AL (US)

(72) Inventors: Martin Kuipers, Dallgow-Döberitz (DE); Richard Lee Goodson, Huntsville, AL (US)

(21) Appl. No.: 15/661,500

(22) Filed: Jul. 27, 2017

(51) Int. Cl. H04L 12/26

(52) U.S. Cl. CPC H04L 43/0864

(57) ABSTRACT

Methods, systems, and apparatus for determining a loop length of a link. In some implementations, a method includes obtaining timing information for bi-directional communications over a link that is being initialized or is in showtime and determining a loop length of the link using the timing information while the link is being initialized or is in showtime. The timing information used while the link is being initialized can include a time value used to align data transmissions over the link. The timing information used while the link is in showtime can include times at which time synchronization events occur on the link while the link is in showtime.

### BACKGROUND

This specification relates to determining the loop length of a link.

The loop length of a link (e.g., the local loop length of a subscriber line) is useful information for an operator to have. The loop length can be used for various purposes, such as assisting in diagnostics of line issues or in the assessment of a line for potential service upgrades. However, not all operators have accurate records of the loop lengths.

### SUMMARY

In general, one innovative aspect of the subject matter described in this specification can be embodied in methods for determining the loop length of a link. One example computer-implemented method includes obtaining timing information for bi-directional communications over a link that is being initialized or is in showtime and determining a loop length of the link using the timing information while the link is being initialized or is in showtime. The timing information used while the link is being initialized can include a time value used to align data transmissions over the link. The timing information used while the link is in showtime can include times at which time synchronization events occur on the link while the link is in showtime.

These and other embodiments can each, optionally, include one or more of the following features. In some aspects, obtaining the timing information can include obtaining the timing information without taking the link out of service and while the link is in initialization or showtime. The times at which the time synchronization events occur can include times at which reference samples used to synchronize times for transceivers that communicate over the link cross particular reference points of the link.

In some aspects, obtaining the timing information can include obtaining times at which the reference samples cross the particular reference points while the link is in showtime. The reference samples can be transmitted over the link periodically while the link is in showtime.

In some aspects, the times at which the time synchronization events occur can include a first time at which a first reference sample crosses a first reference point of the link while the link is in showtime, second time at which the first reference sample crosses a second reference point of the link, a third time at which a second reference sample crosses the second reference point of the link while the link is in showtime, and a fourth time at which the second reference samples crosses the first reference point of the link. Determining the loop length can include determining a propagation delay value based on (i) a first difference between the fourth time and the first time and (ii) a second difference between the third time and the second time and determining the loop length based on the propagation delay value and a propagation speed for physical media of a same type as physical media of the link. The propagation delay value can be proportional to a difference between the first difference and the second difference.

In some aspects, obtaining the timing information can include determining a first gap time during initialization of the link. The first gap time can be assigned as the time value used to align data transmissions over the link. Determining the loop length of the link can include determining a propagation delay value based on a difference between a second gap time and the first gap time. The second gap time can include a first period of time between completion of a downstream transmission by a first transceiver and a beginning of an upstream reception by the first transceiver. The first gap time can include a second period of time between completion of a downstream reception of the downstream transmission by a second transceiver and a beginning of an upstream transmission by the second transceiver. The loop length can be determined based on the propagation delay value and a propagation speed for physical media of a same type as physical media of the link.

In some aspects, the first gap time is determined during initialization and is used by the second transceiver to time transmissions of data to the first transceiver so that the data is received by the first transceiver according to the second gap time.

In some aspects, determining the loop length of the link can include determining a propagation delay value based on a difference between the first gap time and a second gap time. The first gap time can include a first period of time between completion of an upstream transmission by a second transceiver and a beginning of a downstream reception by the second transceiver. The second gap time can be a second period of time between completion of an upstream reception of the upstream transmission by the first transceiver and a beginning of a downstream transmission by the first transceiver. The loop length can be determined based on the propagation delay value and a propagation speed for physical media of a same type as physical media of the link.

Particular embodiments of the subject matter described in this specification can be implemented so as to realize one or more of the following advantages. Techniques described herein allow for the accurate determination of the loop length of a network link without taking the link out of service, without knowing individual characteristics of the loop (e.g., capacitance and/or resistance of the loop per meter) required by metallic line testing or attenuation-based techniques, and without using specialized software or specialized hardware. By using timing information that is normally being collected or determined for the network link while the link is being initialized or is in showtime, no additional data has to be communicated over the link while the link is in initialization or showtime to determine the loop length. This allows for the loop length to be determined without a reduction in the bandwidth or throughput of the link that would occur if additional data had to be communicated over the link to determine the loop length. By keeping the link in service, downtime of the link is prevented and the loop length is determined more quickly.

While some aspects of this disclosure generally describe computer-implemented software embodied on tangible media that processes and transforms data, some or all of the aspects may be computer-implemented methods or further included in respective systems or devices for performing the described functionality. The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram illustrating an example environment in which the loop length of links is determined.

FIG. 2 is a flow chart of an example process for determining the loop length of a link.

FIG. 3 is a time diagram of events that occur on a link.

FIG. 4 is a flow chart of another example process for determining the loop length of a link.

FIG. 5 is an example time-division duplexing (TDD) frame structure.

FIG. 6 is a flow chart of another example process for determining the loop length of a link.

Like reference numbers and designations in the various drawings indicate like elements.

### DETAILED DESCRIPTION

The present disclosure describes methods, systems, and apparatus for determining the loop length of a link, for example, while the link is being initialized and/or while data is being transmitted over the link without taking the link out of service. The link may be a subscriber line of a telephone network. An accurate estimation of the loop length can be helpful in diagnosing issues with the link or assessing the link for potential service upgrades. In some environments, the in-building cabling can represent a significant part of the loop length which is often not well documented. The techniques described herein allow for the accurate determination of such local loop lengths in these environments without taking the link out of service and without knowing the individual characteristics of each installation of in-building cabling.

In some implementations, the loop length of a link can be determined while the link is being initialized or is in showtime and/or based on timing information obtained while the link is being initialized or is in showtime. During initialization of a link, certain tasks are completed to prepare the link for normal data communications. For example, initialization of a link can include tasks that define communication parameters, synchronizing transceivers communicating over the link, identifying channels, cancelling crosstalk, transferring transmission parameters between transceivers, identifying noise, and/or other appropriate tasks related to setting up a link. A link is in showtime when bearer channel data (e.g., primary data or voice communication) is being transmitted over the link, e.g., after the initialization procedure has been completed.

The loop length of a link can be determined using timing information for bi-directional communications over the link during initialization of the link or while the link is in showtime. The timing information used to determine the loop length may differ or be selected based on the state of the link, e.g., based on whether the link is in initialization or showtime. For example, when the link is in showtime, the timing information used to determine the loop length may include times at which time synchronization events occur while the link is in showtime. When the link is being initialized, the timing information used to determine the loop length may include one or more time values (e.g., gap times) that are used to align data transmissions over the link. In both cases, the timing information can be information that is normally being obtained or determined (e.g., by one or more transceivers that communicate over the link) while the link is in that state. For example, the timing information may be information that is required to be collected or determined (e.g., by a transceiver that communicates over the link) based on a telecommunications protocol or standard. Thus, using the techniques described herein, the link does not have to be taken out of service and no additional data has to be communicated over the link other than data that is normally communicated over the link.

The timing information can be used to determine a propagation delay of the link. The propagation delay of a link is the amount of time that it takes for a signal to travel from one end of the link to the other end of the link, e.g., from one transceiver to another transceiver that communicates over the link. The loop length of the link can be determined based on the propagation delay and a propagation speed of the physical media of the link. For example, the loop length for a link may be equal to the determined propagation delay of the link divided by the propagation speed of the link. The propagation speed of a link may be based on a typical or known propagation speed of links having a same type of media as the link. The type of media may be defined by a material of the conductor, an arrangement of the conductors, and/or other appropriate characteristics of the media. For example, the propagation speed of a twisted pair copper cable is about 0.5 microseconds per 100 meters.

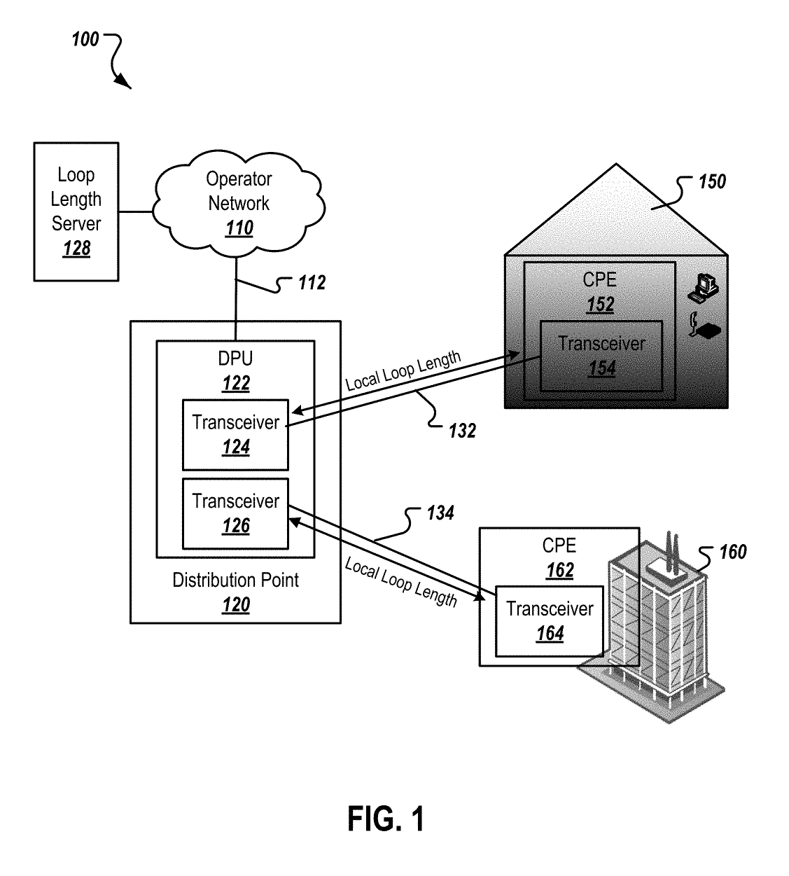

FIG. 1 is a block diagram illustrating an example environment 100 in which the loop length of links is determined. The environment 100 includes a distribution point unit (DPU) 122 that connects users to an operator network 110. The DPU 122 can be located at a distribution point 120 or a central office of the network operator. For example, the operator may have distribution points in various locations near users' premises and that each include one or more DPUs 122 for connecting users to the operator network 110.

The DPU 122 may be connected to the operator network 110 over a broadband link 112, e.g., a fiber-optic link. The DPU 122 includes a transceiver 124 that communicates with the transceiver 154 located at a user's house 150 and a transceiver 126 that communicates with the transceiver 164 located at a commercial facility 160. Although a house 150 and a commercial facility 160 are illustrated in FIG. 1, the DPU 122 can include transceivers that communicate with transceivers at other types of facilities as well. In addition, the distribution point 120 can include more than one DPU 122 for connecting users with the operator network 110. Similarly, the house 150 or commercial facility 160 can include more than one transceiver.

The transceiver 154 can be a part of the customer-premises equipment (CPE) 152 located at the user's house 150. Similarly, the transceiver 164 can be a part of the CPE 162 located at the commercial facility 160. The CPE 152 and 162 can include the transceivers 152 and 162, respectively, and other associated equipment, such as telephones, routers, switches, etc.

The transceiver 124 can communicate with the transceiver 154 over a link 132. Similarly, the transceiver 126 can communicate with the transceiver 164 over a link 134. Each link 132 and 134 can be a subscriber line and include conductors, such as twisted pair conductors, over which data is communicated between the transceivers. In some implementations, each link 132 and 134 is implemented as a G.fast link that conforms to the G.fast protocol standard. In such implementations, the transceivers 124 and 126 may each be referred to as a FTU-O and the transceivers 154 and 164 may each be referred to as an FTU-R. An FTU-O can transmit G.fast signals to and receive G.fast signals from an FTU-R.

The example environment 100 also includes a loop length server 128 that is connected to (e.g., in data communication with) the operator network 110. The loop length server 128 can determine (e.g., estimate) the loop length of the links 132 and 134. The loop length server 128 may be located at an office building of the operator, in a management system of the operator network 110, at the distribution point 120, or at another appropriate location. Regardless of the location, the loop length server 128 may be in data communication with the transceiver 124 and/or the transceiver 126 to obtain timing information for the links 132 and 134 that is used to determine the loop length of the links 132 and 134, as described below.

In some implementations, the transceivers located in the DPU 122 are configured to determine the loop length of links over which the transceivers transmit and receive data. For example, the transceivers 124 and 126 can be configured to determine the loop lengths of the links 132 and 134 based on timing information for the links 132 and 134 received by or determined by the transceivers 124 and 126. The transceivers 124 and 126 can also be configured to transmit data specifying the loop length of each link 132 and 134 to another device, e.g., a server of the operator.

The loop length of the link 132 is the physical length of the link 132 (e.g., the length in meters or feet of a cable that includes the conductors of the link 132) that runs between a connection point at the distribution point 120 and a connection point at the house 150 or other customer location. For example, the connection point at the distribution point 120 may be the transceiver 124, a switch or terminal at the distribution point 120, or another appropriate connection point to which the link 132 can connect and that is inside the premises of the distribution point 120. The connection point at the house 150 may be the transceiver 154, a network interface device, or another appropriate connection point to which the link 132 can connect inside the premises of the house 150.

Similarly, the loop length of the link 134 is the physical length of the link 134 (e.g., the length of a cable that includes the conductors of the link 134) that runs between a connection point at the distribution point 120 and a connection point at the commercial facility 160. The connection point at the commercial facility may be the transceiver 164, a network interface device, or another appropriate connection point to which the link 134 can connect.

The loop length server 128 (or transceiver 124) can determine the loop length of a link without taking the link out of service. For example, the loop length server 128 can determine the loop length of a link while the link is being initialized or while the link is in showtime. The loop length server 128 can determine the loop length of a link based on timing information for the link that is obtained or determined while the link is being initialized or in showtime. The timing information may be stored by one or more of the transceivers, for example, for use in aligning data transmissions or to synchronize clocks of the transceivers. For example, the timing information for the link 132 may be stored by the transceiver 124 and/or the transceiver 154 for use in aligning data transmissions between the transceivers 124 and 154 or to synchronize the clock of the transceiver 124 with the clock of the transceiver 154. Similarly, the timing information for the link 134 can be stored by the transceiver 126 and/or the transceiver 164 for use in aligning data transmissions between the transceivers 126 and 164 or to synchronize the clock of the transceiver 126 with the clock of the transceiver 164. The loop length server 128 can obtain the timing information for the links 132 and 134 from the transceivers 124 and/or 126, e.g., by submitting a request for the data to the transceiver 124 and/or 126. In some implementations, the loop length server 128 can obtain the timing information for the link 132 from the transceiver 154. Similarly, the loop length server 128 can obtain the timing information for the link 134 from the transceiver 164.

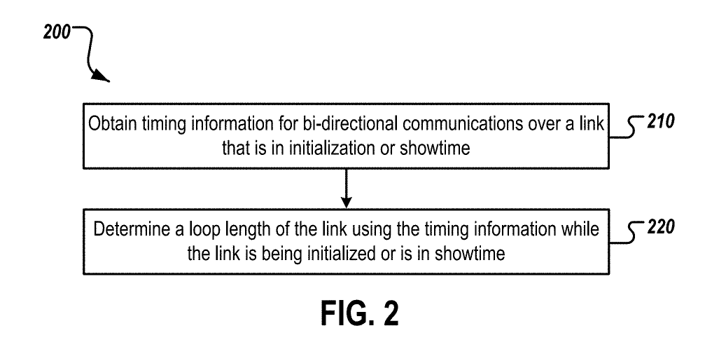

As described above, when the link is in showtime, the timing information used to determine the loop length may include times at which time synchronization events occur while the link is in showtime. When the link is being initialized, the timing information used to determine the loop length may include one or more time values (e.g., gap times) that are used to align data transmissions over the link. Example techniques for determining the loop length of links using timing information are described below with reference to FIGS. 2-6.

FIG. 2 is a flow chart of an example process 200 for determining the loop length of a link. The example process 200 can be performed, for example, by one or more computers and/or one or more telecommunications devices such as those described with reference to FIG. 1. The example process 200 can also be implemented as instructions stored on a non-transitory, computer-readable medium that, when executed by one or more computers or telecommunication devices, configures the one or more computers and/or one or more telecommunications devices to perform and/or cause the one or more computers and/or one or more telecommunications devices to perform the actions of the example process 200.

Time information for bi-directional communications over a link that is in initialization or showtime is obtained (210). The timing information can be information that is normally measured, determined, or collected by a telecommunications device, such as a transceiver. For example, during showtime, the transceiver 154 use time stamps of events to synchronize the time, frequency, and/or phase of the clock of the transceiver 154 with the clock of the transceiver 124. Similarly, the transceiver 164 can use time stamps of events to synchronize the time, frequency, and/or phase of the clock of the transceiver 164 with the clock of the transceiver 126.

In the G.fast recommendation G.9701, the transport of Time-of-Day (ToD) is a mandatory capability to synchronize the clock at the transceiver 154 on the user side of the link 132 with the network clock at the transceiver 124 on the service side of the link 132 and to provide accurate time information at the user side, e.g., for mobile backhauling. Similarly, the transport of ToD synchronizes the clock at the transceiver 164 on the user side of the link 134 with the network clock at the transceiver 126 at on the service side of the link 134. As described in more detail below, the time stamps of four events related to this synchronization can be used as the timing information that is used to determine the propagation delay of the link. As this synchronization technique is required for G.fast links that conform to the G.fast recommendation G.9701, no additional data has to be communicated over a G.fast link to determine the propagation delay of the link and the loop length of the link. As the synchronization technique is performed while the link is in showtime, the link can continue operating in showtime without being taken out of service.

Some implementations of G.fast and/or other standards may not support the transport of ToD. In such cases and/or in cases in which the loop length is to be determined while the link is in initialization, another technique can be used to determine the propagation delay of the link for use in determining the loop length. During initialization, the transceivers 124 and 126 on the operator side of the links 132 and 134 determines respective time gaps that are used to align data transmissions. For example, when using Time Division Duplex (TDD) to multiplex downstream and upstream transmissions, there may be a time gap between the two transmission directions. As described in more detail below, these time gaps can be used to determine the propagation delay of the link because the transceivers 124, 126, 154, and 164 can use the time gaps to align the timing of upstream and downstream transmissions. Alignment of the transmission timing at the receiver is required for a proper operation of vectoring. Thus, the timing information used when a link is in initialization may be the values of one or more time gaps used to align data transmissions over the link.

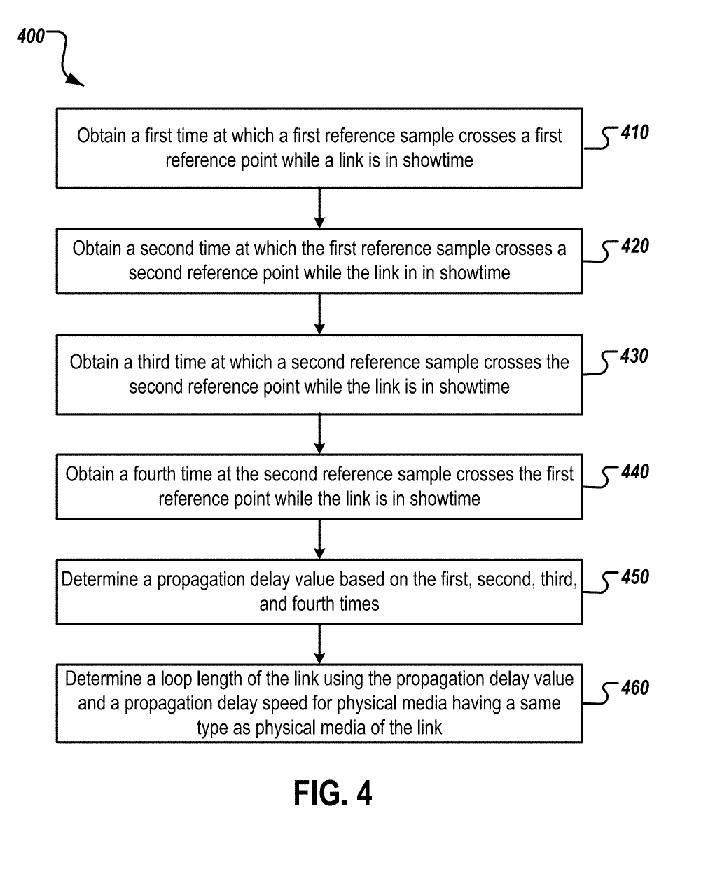

A loop length of the link is determined using the timing information while the link is being initialized or is in showtime (220). When the link is in showtime, a propagation delay value that represents the propagation delay of the link can be determined using the time stamps of the events. The loop length of the link can be determined based on the determined propagation delay value and a propagation speed of the link. The propagation speed of the link may be the propagation speed for physical media of a same type as physical media of the link. For example, if the physical media is twisted pair copper cables, a propagation speed of 0.5 microseconds per 100 meters may be used. The loop length may be determined by dividing the determined propagation delay value by the propagation speed. An example process for determining a loop length of a link while the link is in showtime is illustrated in FIG. 4 and described below.

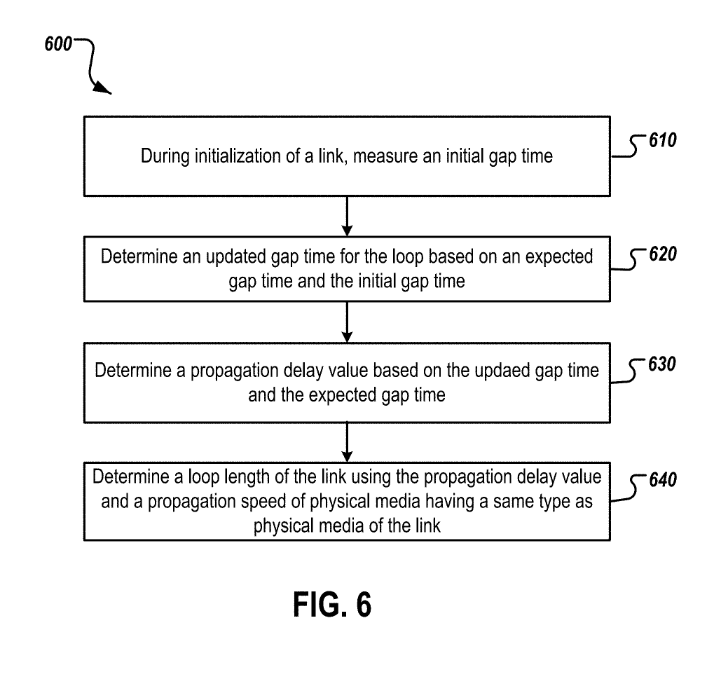

When the link is being initialized or for links that do not support the transport of ToD, a propagation delay value that represents the propagation delay of the link can be determined using the time gap values determined during initialization. The loop length can be determined by dividing the determined propagation delay value by the propagation speed for physical media of a same type as the physical media of the link. An example process for determining a loop length of a link while the link is in showtime is illustrated in FIG. 6 and described below.

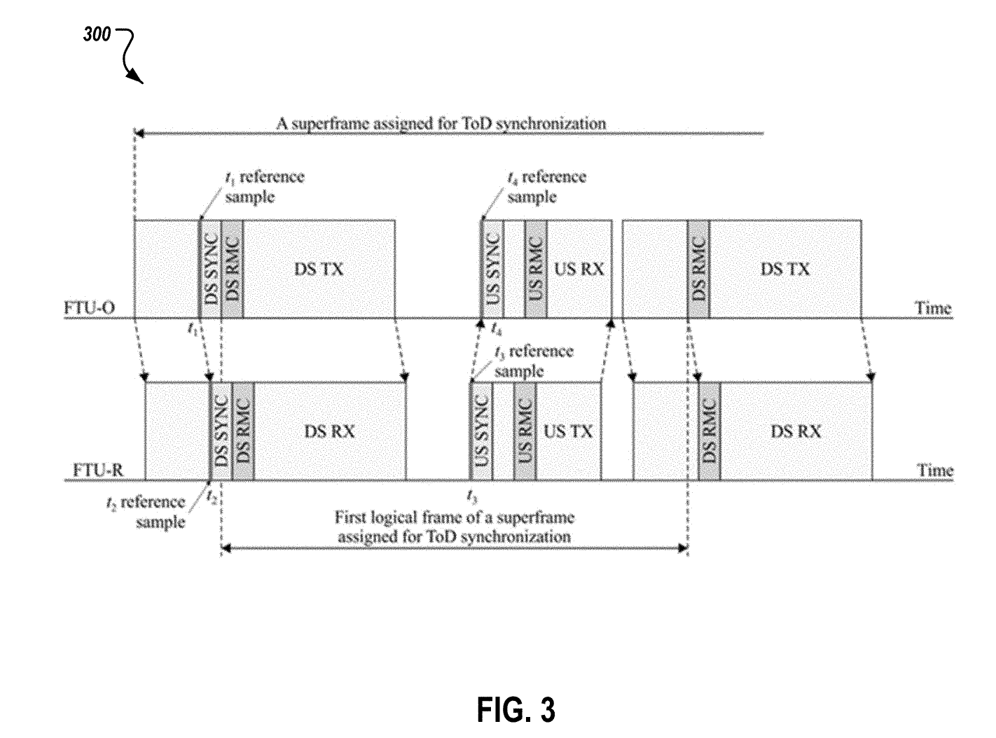

FIG. 3 is a time diagram 300 of events that occur on a link, such as the link 132 of FIG. 1 or the link 134 of FIG. 1. In this example, the link conform to G.fast recommendation G.9701 and supports the transport of ToD. The timeline 300 depicts a superframe assigned for ToD synchronization and times at which reference samples of synchronization symbols cross particular interfaces of the link.

In the superframe, an operator side transceiver FTU-O (e.g., the transceiver 124 of FIG. 1) transmits a downstream synchronization symbol to a user side transceiver FTU-R (e.g., the transceiver 154 or 164 of FIG. 1) over the link. In response to receiving the downstream synchronization symbol, the FTU-R transmits an upstream synchronization symbol to the FTU-O.

At time t₁, a reference sample of the downstream synchronization symbol crosses a first reference point. For example, the time ti may be the time at which the reference sample of the downstream synchronization symbol crosses a U-O interface of the FTU-O. The FTU-O may identify the time at which the reference sample of the downstream synchronization symbol crosses the first reference point and store the time as time t₁ in memory of the FTU-O.

At time t₂, the reference sample of the downstream synchronization symbol crosses a second reference point. For example, the time t₂ may be the time at which the reference sample of the downstream synchronization symbol crosses a U-R interface of the FTU-R. The FTU-R may identify the time at which the reference sample of the downstream synchronization symbol crosses the second reference point and store the time as time t₂ in memory of the FTU-R.

As mentioned above, the FTU-R sends an upstream synchronization symbol to the FTU-O after receiving the downstream synchronization symbol. At time t₃, a reference sample of the upstream synchronization symbol crosses the second reference point, e.g., the U-R interface of the FTU-R. The FTU-R may identify the time at which the reference sample of the upstream synchronization symbol crosses the second reference point and store the time as time t₃ in memory of the FTU-R.

At time t₄, the reference sample of the upstream synchronization symbol crosses the first reference point, e.g., the U-O interface of the FTU-O. The FTU-O may identify the time at which the reference sample of the upstream synchronization symbol crosses the first reference point and store the time as time t₄ in memory of the FTU-O.

The FTU-O may transmit the values of t₁ and t₄ to the FTU-R. A ToD function of the FTU-R can use the four times (t₁, t₂, t₃, t₄) to synchronize its clock to the clock of the FTU-O. The FTU-R can also transmit the values of t₂ and t₃ to the FTU-O, e.g., after synchronization has completed.

The FTU-O can transmit the values of t₁, t₂, t₃, and t₄ to a loop length server, e.g., the loop length server 128 of FIG. 1. The loop length server can determine a propagation delay value that represents the propagation delay of the link using the four times t₁, t₂, t₃, and t₄. For example, the propagation delay of the link can be determined using the times t₁, t₂, t₃, and t₄ and the following relationship:

$${T}_{pd} = \frac{( ( {t}_{4} - {t}_{1} ) - ( {t}_{3} - {t}_{2} ) )}{2} \qquad ( 1 )$$

In Relationship 1, T_{pd} represents the propagation delay of the loop. The loop length server can also determine a loop length for the link using the following relationship:

$$L L = \frac{{T}_{pd}}{Tps} \qquad ( 2 )$$

In Relationship 2, LL represents the loop length of the link, T_{pd} represents the propagation delay determined using Relationship 1, and Tₚₛ represents the propagation speed of the physical media of the link. For example, if the link is a twisted pair copper cable, Tₚₛ may be 0.5 microseconds per 100 meters.

The FTU-O and the FTU-R may perform this ToD synchronization process periodically while the link is in showtime to ensure that their clocks are synchronized. Thus, the times t₁, t₂, t₃, and t₄ can be periodically obtained and stored by the FTU-O and/or the FTU-R, and used to determine the propagation delay of the link. By using these time values to determine the propagation delay and the loop length, the link does not have to be taken out of service and no additional data has to be transmitted over the link to determine the loop length.

In some implementations, the propagation delay of the link may be determined based on the time values of multiple synchronizations. For example, a first propagation delay value may be determined based on the times t₁, t₂, t₃, and t₄ obtained during a first time synchronization performed for the link. One or more additional propagation delay values may be determined based on times t₁, t₂, t₃, and t₄ obtained during subsequent time synchronizations performed for the link. The determined propagation delays can be averaged to determine an average propagation delay for the link. The average propagation delay can be divided by the propagation speed of the physical media of the link to determine the loop length of the link.

FIG. 4 is a flow chart of another example process 400 for determining the loop length of a link. The example process 400 is described with reference to the time diagram 300 of FIG. 3. The example process 400 can be performed, for example, by one or more computers and/or one or more telecommunications devices such as those described with reference to FIG. 1. The example process 400 can also be implemented as instructions stored on a non-transitory, computer-readable medium that, when executed by one or more computers or telecommunication devices, configures the one or more computers and/or one or more telecommunications devices to perform and/or cause the one or more computers and/or one or more telecommunications devices to perform the actions of the example process 400.

A first time t₁ is obtained (410). As described above, the first time t₁ may be a time at which a first reference sample of a first synchronization symbol crosses a first reference point (e.g., the U-O interface) of a link while the link is in showtime. For example, an operator side transceiver (FTU-O) may transmit the first synchronization symbol to a user side transceiver (FTU-R) as part of a ToD time synchronization process. The FTU-O may identify and record the time at which the first reference sample crosses the first reference point as the first time t₁. A loop length server may obtain the first time t₁ from the FTU-O.

A second time t₂ is obtained (420). As described above, the second time t₂ may be a time at which the first reference sample of the first synchronization symbol crosses a second reference point (e.g., the U-R interface) of the link while the link is in showtime. The FTU-R may identify and record the time at which the first reference sample crosses the second reference point as the second time t₂. A loop length server may obtain the second time t₂ from the FTU-R or from the FTU-O. For example, the FTU-R may transmit the second time t₂ to the FTU-O after a ToD synchronization process for which the second time t₂ was obtained has completed.

A third time t₃ is obtained (430). As described above, the third time t₃ may be a time at which a second reference sample of a second synchronization symbol crosses the second reference point of the link while the link is in showtime. For example, the FTU-R may transmit the second synchronization symbol to the FTU-O as part of a ToD time synchronization process. The FTU-R may identify and record the time at which the second reference sample crosses the second reference point as the third time t₃. A loop length server may obtain the third time t₃ from the FTU-R or from the FTU-O. For example, the FTU-R may transmit the third time t₃ to the FTU-O after a ToD synchronization process for which the time t₃ was obtained has completed.

A fourth time t₄ is obtained (440). As described above, the fourth time t₄ may be a time at which the second reference sample of the second synchronization symbol crosses the first reference point of the link while the link is in showtime. The FTU-O may identify and record the time at which the second reference sample crosses the first reference point as the fourth time t₄. A loop length server may obtain the fourth time t₄ from the FTU-O.

A propagation delay value is determined based on the times t₁, t₂, t₃, and t₄ (450). For example, the propagation delay value may be determined using Relationship 1 above and times t₁, t₂, t₃, and t₄.

A loop length of the link is determined using the propagation delay value and a propagation delay speed of physical media having a same type as physical media of the link (460). For example, the loop length of the link may be determined using Relationship 2 above, the determined propagation delay value, and the propagation delay speed.

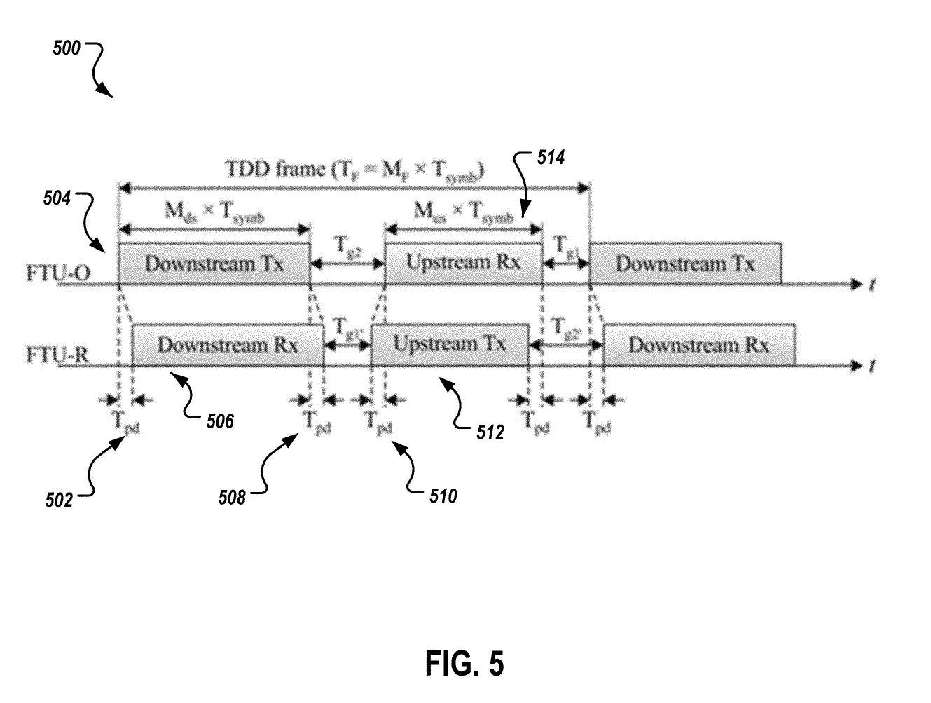

FIG. 5 depicts an example TDD frame structure 500. In the example TDD frame, there is a time gap between the two transmission directions. For example, the values of T_{g1} and T_{g2} are gap times at the U-O interface of the FTU-O. In particular, T_{g2} is an expected period of time between a time at which a downstream transmission from the FTU-O ends and a time at which an upstream reception begins at the FTU-O. Similarly, T_{g1} is a period of time between a time at which an upstream reception at the FTU-O ends and a downstream transmission by the FTU-O begins. Thus, after the upstream reception by the FTU-O ends, the FTU-O waits a period of time equal to T_{g1} before initiating a downstream transmission.

The values of T_{g1′} and T_{g2′} are gap times at the U-R interface of the FTU-R. T_{g1′} is a period of time between a time at which a downstream reception by the FTU-R ends and an upstream transmission by the FTU-R begins. T_{g2′} is an expected period of time between a time at which an upstream transmission by the FTU-R ends and a downstream reception by the FTU-R begins.

Per the G.fast protocol, the actual value of T_{g1′} for a link is determined during initialization of a link. The value of T_{g1′} is determined such that the beginning of an upstream transmission by the FTU-R is received by the FTU-O a period of time equal to T_{g2} after the downstream transmission by the FTU-O has completed. Thus, the value of T_{g1′} is based on the actual propagation delay of the link. For example, as shown in FIG. 5, there is propagation delay 502 between the beginning of the first downstream transmission 504 by the FTU-O and the beginning of the first downstream reception 506 by the FTU-R. This propagation delay represents the time taken for data to traverse the link from the FTU-O to the FTU-R. Similarly, there is a propagation delay 508 between the end of the first downstream transmission 504 and the end of the first downstream reception 506 and a propagation delay 510 between the beginning of the first upstream transmission 512 by the FTU-R and the beginning of the first upstream reception 514 by the FTU-O. The value of T_{g1′} is determined such that the beginning of the upstream reception 514 by the FTU-O begins a period of time T_{g2} after the downstream transmission 504 by the FTU-O ends accounting for these propagation delays. The value of T_{g1′} is communicated to the FTU-R. The FTU-R uses the value of T_{g1′} value to determine when to begin an upstream transmission after a downstream reception is completed.

The FTU-O can store in memory the determine value of T_{g1′}. The value of T_{g1′} can be updated during initialization until the value of T_{g1′} results in data transmissions being received by the FTU-O a period of time equal to (or within an acceptable threshold of) the value of T_{g2} after a downstream transmission by the FTU-O has completed. The updated value of T_{g1′} can be stored by the FTU-O and transmitted to the FTU-R.

The values of T_{g1′} and T_{g2} can be used to determine the propagation delay of the link. For example, the propagation delay of the link may be determined using the following relationship:

$${T}_{pd} = \frac{( {T}_{g 2} - {T}_{g {1}^{′}} )}{2} \qquad ( 3 )$$

The propagation delay T_{pd} can be used to determine the loop length of the link using Relationship 2 above.

FIG. 6 is a flow chart of another example process 600 for determining the loop length of a link. The example process 600 is described with reference to the example TDD frame structure 500 of FIG. 5. The example process 600 can be performed, for example, by one or more computers and/or one or more telecommunications devices such as those described with reference to FIG. 1. The example process 600 can also be implemented as instructions stored on a non-transitory, computer-readable medium that, when executed by one or more computers or telecommunication devices, configures the one or more computers and/or one or more telecommunications devices to perform and/or cause the one or more computers and/or one or more telecommunications devices to perform the actions of the example process 600.

During initialization of a link, an initial gap time is measured (610). For example, during initialization, an initial value for T_{g2} may be measured. At the beginning of initialization, the FTU-O may set the time gap T_{g1′} to an initial value to cover an expected range of the loop length for a particular distribution point. The FTU-O can provide the initial value of T_{g1′} to the FTU-R and the FTU-R can use the initial value of Tg1′ to time upstream transmissions to the FTU-O. During initialization, the FTU-O can measure the actual value of the time gap T_{g2}.

An updated gap time T_{g1′} for the loop is determined based on an expected gap time T_{g2} and the initial gap time T_{g1′} (620). During initialization, the FTU-O may adjust the value of T_{g1′} based on the time at which the beginning of the upstream transmissions are received by the FTU-O from the FTU-R and an expected gap time T_{g2}. As described above, the value of T_{g2} is an expected period of time between a time at which a downstream transmission from the FTU-O ends and a time at which an upstream reception begins at the FTU-O. If reception of the upstream transmission begins later than expected (e.g., later than a period of time equal to T_{g2} after completing of a downstream transmission), the FTU-R may be instructed to decrease the value of T_{g1′}. If reception of the upstream transmission begins earlier than expected (e.g., earlier than a period of time equal to T_{g2} after completing of a downstream transmission), the FTU-R may be instructed to increase the value of T_{g1′} so that the FTU-O waits a longer period of time before beginning data transmissions to the FTU-R after reception of data from the FTU-O has completed. During initialization, the gap time T_{g1′} can be iteratively updated based on measured values of the gap time T_{g2} until the actual gap time T_{g2} equals or is within a threshold amount of the expected value of the gap time T_{g2}.

A propagation delay value is determined based on the updated gap time T_{g1′} and the gap time T_{g2} (630). For example, a loop length server may obtain the values of T_{g1′} and T_{g2} from the FTU-O and determine the propagation delay value using Relationship 3 above.

A loop length of the link is determined using the propagation delay value and a propagation speed of physical media having a same type as physical media of the link (640). For example, the loop length of the link may be determined using Relationship 2 above, the determined propagation delay value, and the propagation speed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
obtaining timing information for bi-directional communications over a link that is being initialized or is in showtime; and
determining a loop length of the link using the timing information while the link is being initialized or is in showtime, wherein:
the timing information used while the link is being initialized comprises a time value used to align data transmissions over the link; and
the timing information used while the link is in showtime comprises times at which time synchronization events occur on the link while the link is in showtime.

2. The method of claim 1, wherein obtaining the timing information comprises obtaining the timing information without taking the link out of service and while the link is in initialization or showtime.

3. The method of claim 1, wherein the times at which the time synchronization events occur comprises times at which reference samples used to synchronize times for transceivers that communicate over the link cross particular reference points of the link.

4. The method of claim 1, wherein obtaining the timing information comprises obtaining times at which the reference samples cross the particular reference points while the link is in showtime, the reference samples being transmitted over the link periodically while the link is in showtime.

5. The method of claim 1, wherein the times at which the time synchronization events occur comprises:
a first time at which a first reference sample crosses a first reference point of the link while the link is in showtime;
a second time at which the first reference sample crosses a second reference point of the link;
a third time at which a second reference sample crosses the second reference point of the link while the link is in showtime; and
a fourth time at which the second reference samples crosses the first reference point of the link.

6. The method of claim 5, wherein determining the loop length comprises:
determining a propagation delay value based on (i) a first difference between the fourth time and the first time and (ii) a second difference between the third time and the second time; and
determining the loop length based on the propagation delay value and a propagation speed for physical media of a same type as physical media of the link.

7. The method of claim 6, wherein the propagation delay value is proportional to a difference between the first difference and the second difference.

8. The method of claim 1, wherein obtaining the timing information comprises determining a first gap time during initialization of the link, the method further comprising assigning the first gap time as the time value used to align data transmissions over the link.

9. The method of claim 8, wherein determining the loop length of the link comprises:
determining a propagation delay value based on a difference between a second gap time and the first gap time, wherein:
the second gap time comprises a first period of time between completion of a downstream transmission by a first transceiver and a beginning of an upstream reception by the first transceiver; and
the first gap time comprises a second period of time between completion of a downstream reception of the downstream transmission by a second transceiver and a beginning of an upstream transmission by the second transceiver; and
determining the loop length based on the propagation delay value and a propagation speed for physical media of a same type as physical media of the link.

10. The method of claim 9, wherein the first gap time is determined during initialization and is used by the second transceiver to time transmissions of data to the first transceiver so that the data is received by the first transceiver according to the second gap time.

11. The method of claim 8, wherein determining the loop length of the link comprises:
determining a propagation delay value based on a difference between the first gap time and a second gap time, wherein:
the first gap time comprises a first period of time between completion of an upstream transmission by a second transceiver and a beginning of a downstream reception by the second transceiver; and
the second gap time comprises a second period of time between completion of an upstream reception of the upstream transmission by the first transceiver and a beginning of a downstream transmission by the first transceiver; and
determining the loop length based on the propagation delay value and a propagation speed for physical media of a same type as physical media of the link.

12. A system, comprising:
a data processing apparatus; and
a memory storage apparatus in data communication with the data processing apparatus, the memory storage apparatus storing instructions executable by the data processing apparatus and that upon such execution cause the data processing apparatus to perform operations comprising:
obtaining timing information for bi-directional communications over a link that is being initialized or is in showtime; and
determining a loop length of the link using the timing information while the link is being initialized or is in showtime, wherein:
the timing information used while the link is being initialized comprises a time value used to align data transmissions over the link; and
the timing information used while the link is in showtime comprises times at which time synchronization events occur on the link while the link is in showtime.

13. The system of claim 12, wherein obtaining the timing information comprises obtaining the timing information without taking the link out of service and while the link is in initialization or showtime.

14. The system of claim 12, wherein the times at which the time synchronization events occur comprises times at which reference samples used to synchronize times for transceivers that communicate over the link cross particular reference points of the link.

15. The system of claim 12, wherein obtaining the timing information comprises obtaining times at which the reference samples cross the particular reference points while the link is in showtime, the reference samples being transmitted over the link periodically while the link is in showtime.

16. The system of claim 12, wherein the times at which the time synchronization events occur comprises:
a first time at which a first reference sample crosses a first reference point of the link while the link is in showtime;
a second time at which the first reference sample crosses a second reference point of the link;
a third time at which a second reference sample crosses the second reference point of the link while the link is in showtime; and
a fourth time at which the second reference samples crosses the first reference point of the link.

17. The system of claim 16, wherein determining the loop length comprises:
determining a propagation delay value based on (i) a first difference between the fourth time and the first time and (ii) a second difference between the third time and the second time; and
determining the loop length based on the propagation delay value and a propagation speed for physical media of a same type as physical media of the link.

18. The system of claim 17, wherein the propagation delay value is proportional to a difference between the first difference and the second difference.

19. The system of claim 12, wherein obtaining the timing information comprises determining a first gap time during initialization of the link, the method further comprising assigning the first gap time as the time value used to align data transmissions over the link.

20. A non-transitory computer program product storing software code portions that are directly loadable into a memory of a digital processing device, wherein execution of the software code portions cause the digital processing device to perform operations comprising:
obtaining timing information for bi-directional communications over a link that is being initialized or is in showtime; and
determining a loop length of the link using the timing information while the link is being initialized or is in showtime, wherein:
the timing information used while the link is being initialized comprises a time value used to align data transmissions over the link; and
the timing information used while the link is in showtime comprises times at which time synchronization events occur on the link while the link is in showtime.
